(19) United States
(12) Patent Application Publication
(10) Pub. No.: US 2018/0029172 A1
(43) Pub. Date: Feb. 1, 2018

(54) TOOL FOR WELDING A BRACKET ONTO A TUBE, TUBE FOR A TANK

(71) Applicant: Plastic Omnium Advanced Innovation and Research, Brussels (BE)

(72) Inventors: Jeremie TONDU, Paris (FR); Alain POTIER, Fresnoy la Riviere (FR)

(73) Assignee: Plastic Omnium Advanced Innovation and Research, Brussels (BE)

(21) Appl. No.: 15/551,069

(22) PCT Filed: Feb. 15, 2016
(86) PCT No.: PCT/EP2016/053193

§ 371 Date: Aug. 15, 2017

(30) Foreign Application Priority Data
Feb. 16, 2015 (FR) 1551278

(51) Int. Cl. B23K 37/053; B60K 15/01; B23K 20/02

(52) U.S. Cl. CPC B23K 37/0536; B23K 20/02; B60K 15/01

(57) ABSTRACT

The tool for welding of a mounting bracket on a tube for a tank comprises means for gripping of the tube, which clear access to a surface on the tube which is designed to be welded, means for heating of the surface which are mobile relative to the means for gripping of the tube, between a position of heating of the surface and a retracted position, means for heating of the mounting bracket, and means for gripping of the bracket which are mobile relative to the means for heating of the bracket and relative to the means for gripping of the tube, between a position for heating of the mounting bracket and a position for welding of the mounting bracket on the surface of the tube.

The invention relates to the assembly of tubes for motor vehicles, and in particular to the addition of components such as brackets for mounting on tubes of this type.

In an assembled motor vehicle, the filling tube is connected in fluid communication, firstly to the tank and secondly to an orifice, covered with a flap, which allows a user to introduce fuel into the tank by means of an appropriate pump.

The tube is secured in the vehicle by means of one or a plurality of mounting brackets. These brackets are welded on the tube, and comprise means for securing on other parts of the vehicle.

At present, in order to weld each mounting bracket on the tube, the tube is retained such that it is disposed on seats which match the form of the tube exactly. The cross section of a tube according to the prior art, in its section which receives the welded mounting bracket, is represented in FIGS. 2 and 3, in which it can be seen that the tube has a flattened part which acts as a welding area.

By means of an appropriate tool, the flattened part, which is the surface of the tube designed to be welded, is heated, the mounting bracket is heated, then the mounting bracket is welded on the tube, by applying it against the surface of the tube, and exerting strong pressure. This pressure does not give rise to deformation of the tube, since the seats retain the tube, whilst limiting the concentrations of stresses.

Thus, the seats on which the tube is supported are specific to each section of tube which they receive. They are formed and arranged especially on a work station.

The seats which receive the tube on the work station match the outer surface of the tube exactly, which prevents concentrations of stress by means of good distribution of the supports.

In addition, the tool which makes it possible to carry out the welding on each section has a particular position on the work station, specific to the mounting bracket to be welded.

On a work station, the specific seats and the adjustments of position of the tool make it possible to carry out good quality welding, without damage to the tube.

For a given vehicle, it often happens that the form of the tube varies from one model to another, for example between the five-door model and the sedan, or between the sedan and the two-door sedan, which involves as many work stations as there are models.

An objective of the invention is to provide a more flexible welding tool, which in particular can adapt to different sections of the same tube, or to different geometric variants of a tube.

For this purpose, a welding tool as claimed in claim 1 is proposed.

Advantageously, the welding tool comprises:
means for gripping of the tube, which are designed to retain the tube and the tool in a position fixed relative to one another, whilst clearing access to a flattened part which is a surface of the tube designed to be welded on the component;
means for heating of the flattened part, which are mobile relative to the means for gripping of the tube, between a position for heating of the flattened part and a retracted position;
means for heating of the component; and
means for gripping of the component, which are mobile relative to the means for heating of the component and relative to the means for gripping of the tube, between a position for heating of the component, and a position for welding of the component onto the flattened part.

Thus, a single tool supports the means for gripping of the tube and the means necessary for carrying out the welding. Consequently, it is no longer necessary to provide seats with a form specific to each section of the tube which is to receive a component.

In addition, by simply displacing the tool to different successive preset positions, it is possible to weld different components in different locations along the tube, without needing to displace the tube from one work station to another work station.

In addition, by modifying the pre-settings for positioning of the tool so as to make it adopt a succession of positions which depend on the tube model to be assembled, it is possible to use the same equipment to weld components on tubes which are destined for different models of motor vehicles, without needing to change work stations. It is sufficient to adjust the positions of the tool for each model of tube. For example, if a robot is responsible for positioning the tool at one or a plurality of sections of the tube, the programming of the robot will take into account the geometry of the tube, and can change according to the model of tube.

In the tool according to the invention, the means for gripping of the tube are polyvalent, in the sense that they need not be formed so as to match the form of a particular section of tube exactly. On the contrary, they can accept any section of a tube, the dimensions of which are within the ranges which cover most known variants of tubes for a cross section with a common form, i.e. globally round (for example circular, oval, oblong) or angular (for example square, rectangular, triangular).

Preferably, the means for gripping of the tube are designed to orient and position the tube relative to the tool in a predetermined position and orientation.

Thus, the gripping means ensure accurate positioning of the tube without external intervention. The heating of the entire surface of the tube is thus homogeneous.

According to one embodiment, the means for heating of the flattened part and the means for heating of the component are combined, for example in the form of a common mirror.

According to one embodiment, the means for heating of the flattened part and the means for gripping of the component are integral in translation in a first direction (X). The means for heating of the component for their part are fixed relative to the means for heating of the flattened part and the means for gripping of the component.

The production of the tool is therefore simpler, since a single drive unit is used for movement of both the means for heating of the tube and the means for gripping of the component.

Preferably, the means for heating of the flattened part are mobile in translation in a second direction (Y), which is preferably transverse to the first direction (X), relative to the means for gripping of the tube.

The displacement of the means for heating of the surface of the tube is then easy to program.

Advantageously, the means for gripping of the tube comprise a jaw. The jaw comprises at least one upper tooth and one lower tooth, with the upper tooth comprising at least one flat inner surface which can come into contact with the flattened part, and the lower tooth comprising at least one second flat inner surface which can come into contact with at least one flat reference flank provided on the tube, with the flat reference flank being such that it makes it possible to position the flattened part opposite the means for heating of the flattened part, when the upper and lower teeth approach one another.

This is a gripping means which is simple to produce.

According to a preferred embodiment, the upper tooth comprises two first flat inner surfaces which are arranged relative to one another such as to form a “V”, and the lower tooth comprises two second flat inner surfaces which are arranged relative to one another such as to form a “V”.

According to one embodiment, the means for gripping of the tube comprise at least one detector and/or one microprocessor which are designed to control the position of the flattened part.

The risk of error is thus minimized.

Preferably, the heating means comprise a heating element and a plate which is heated by the heating element.

Advantageously, the means for heating of the flattened part comprise at least one detector and/or one microprocessor which are designed to control the position of the heating means relative to the tube.

Preferably, the means for gripping of the component comprise at least one detector and/or one microprocessor which are designed to control the position of the gripping means relative to the tube.

The risk of error is thus minimized.

According to a particular embodiment of the invention, the welding tool is designed to weld a component of the mounting bracket type, making it possible to secure the tube on a part of a motor vehicle.

According to another embodiment, the welding tool is designed to weld a component of the line bracket type, making it possible to attach the tube to another tube.

Advantageously, the tool is designed to be used for securing of a tube for filling of a tank.

According to one embodiment, the tool is designed to be used for securing of a tube of a motor vehicle.

Preferably, the tool is designed to be used for securing of a tube for filling of a fuel tank, for example of a motor vehicle.

Also according to the invention, a tube for a fuel tank is provided, characterized in that it has a form which is designed to be used with a tool as previously described and a component welded by means of the tool.

During welding, the adapted form makes it possible to combine the flattened part and a regular heating area of the means for heating of the surface. Good quality welding is therefore certain to be obtained.

Also according to the invention, a tube for a tank is provided, characterized in that its wall comprises a flattened part, and, on both sides of this flattened part in a direction transverse to the tube, two flat flanks perpendicular to this flattened part.

The perpendicular flat flanks are designed to cooperate with the means for gripping of the tube, and more particularly with the flat inner surfaces of the teeth of the jaw.

The flat flanks make it possible for the flattened part to be disposed opposite the means for heating of the surface, in order to obtain homogenous heating of the flattened part.

Preferably, the tube comprises at least one projection which is designed to cooperate with means for gripping of the tube of a tool, in order to control the position of the tube relative to this tool.

Advantageously, the tube is designed to be used as a tube for filling of a fuel tank, for example of a motor vehicle.

Finally, according to the invention, an installation is provided for welding of at least one component on a tube as previously mentioned, comprising a tool as previously described, and a robot which is designed to position the tool relative to the tube.

A description will now be provided, by way of non-limiting example, of an embodiment of the invention, by means of the following figures:

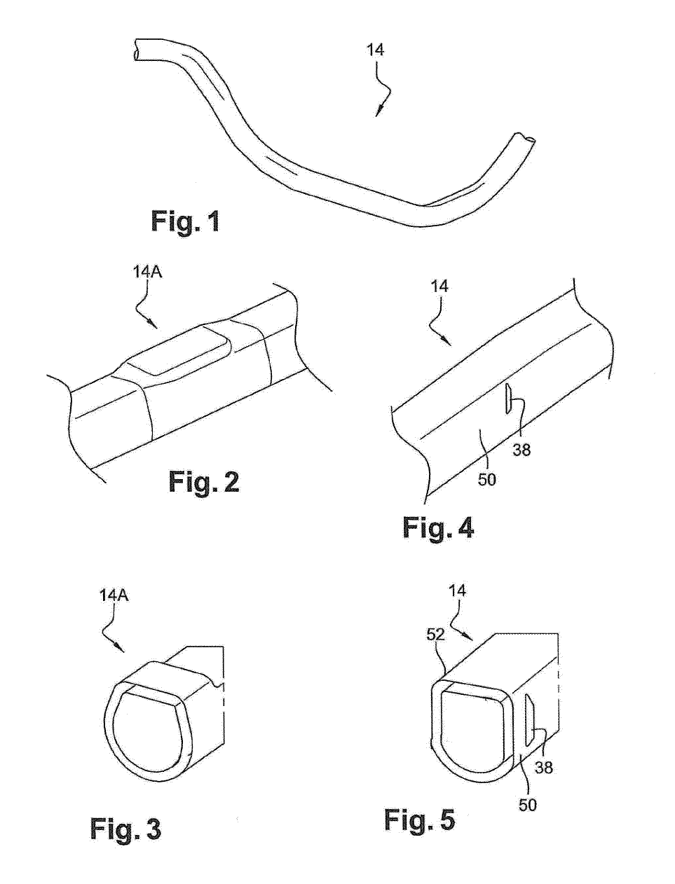

FIG. 1 is a view in perspective of a tube according to an embodiment of the invention;

FIGS. 2 and 3 are views in perspective and in cross section in a direction transverse to that of the tube, of a tube according to the prior art;

FIGS. 4 and 5 are views in perspective and in cross section in a direction transverse to that of the tube, of the tube according to the invention;

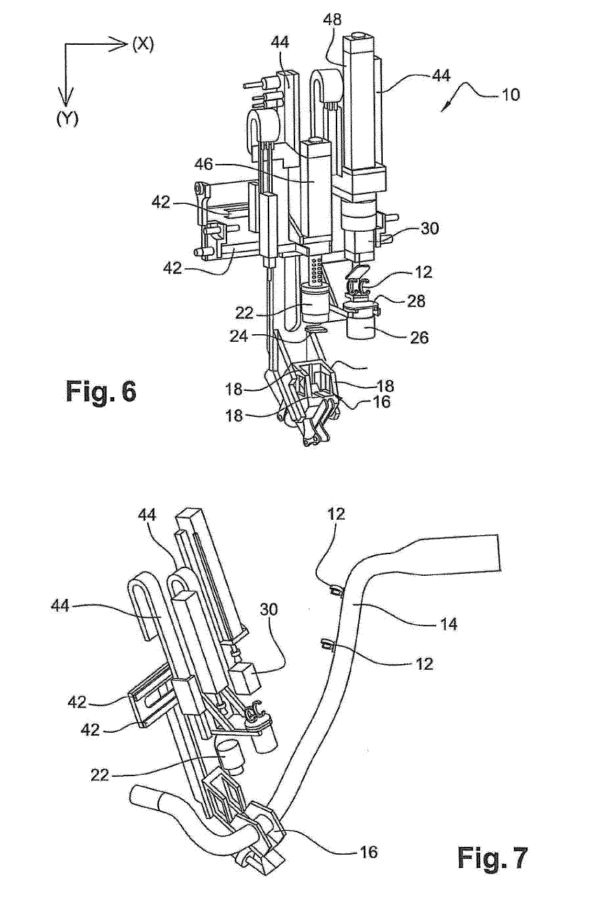

FIG. 6 is a view in perspective of a tool according to an embodiment of the invention;

FIG. 7 is a view in perspective of the tool engaged with a tube according to the invention;

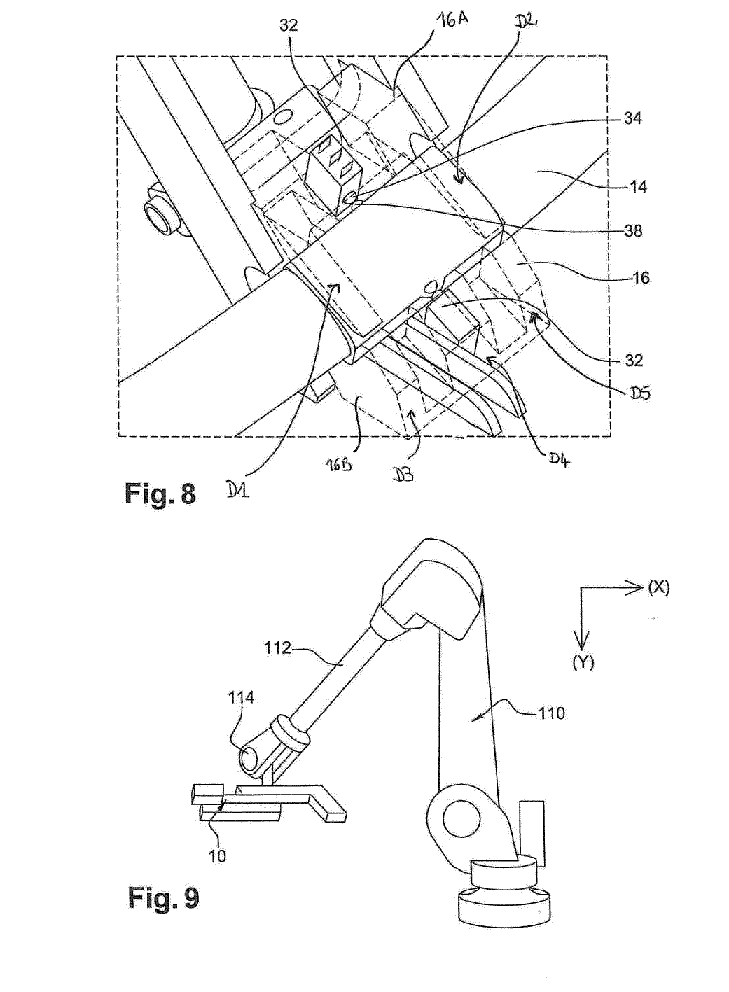

FIG. 8 is a view in perspective of means for gripping of the tool;

FIG. 9 is a view in perspective of a robot supporting a tool;

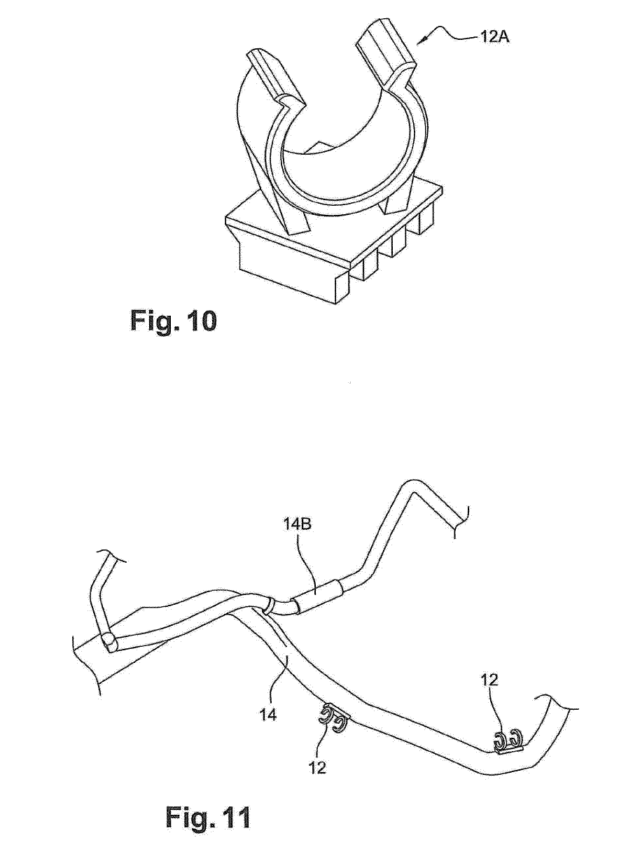

FIG. 10 is a view in perspective of another example of a component which can be welded on the tube according to the invention; and

FIG. 11 represents the tube attached to another tube, thanks to the component in FIG. 10;

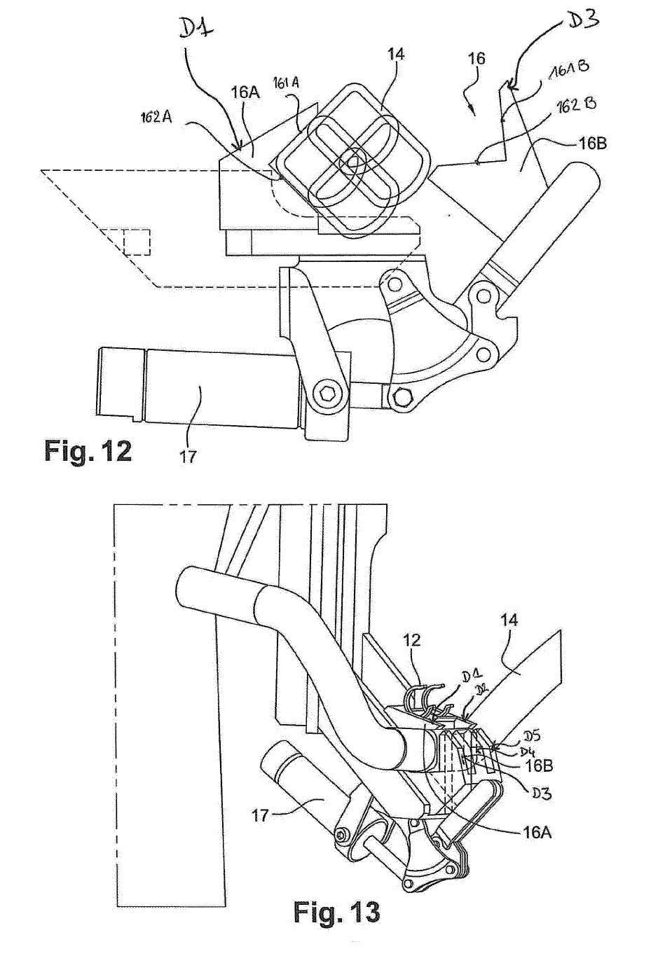

FIG. 12 represents schematically the gripping of the tube by the means for gripping of the tool; and

FIG. 13 represents the component in FIG. 10 at the end of the step of welding by the tool 10, on the tube.

With reference to FIGS. 1, 4 and 5, a description will firstly be provided of a tube 14 according to an embodiment of the invention.

The tube 14 is a tube for filling of a fuel tank of a motor vehicle, according to the invention. This tube 14 is designed so that at least one mounting bracket can be secured on it by means of a welding tool according to the invention.

FIGS. 2 and 3 show a tube 14A according to the prior art, by way of comparison.

The surface 20 of the tube 14 which is designed to be welded is in the form of a flattened part. On both sides of this flattened part 20, in a direction transverse to the tube 14, the latter comprises two flat flanks 50, 52 which are perpendicular to this flattened part.

In comparison, the flanks which are perpendicular to the welding surface 20 of the tube 14A are not flat. According to the prior art, the part of the tube 14A which supports the surface 20 designed to be welded was supported on a seat matching its form exactly at the moment of welding of the mounting bracket. Thus, this seat positioned and oriented the tube relative to the means for heating of the surface of the tube designed to be welded. Thanks to the form of the tube according to the present embodiment of the invention, the flat flanks 50, 52 which are perpendicular to the flattened part 20 allow the tube 14 to be able to be positioned and oriented by means supported by the tool, which will be described hereinafter.

In this case, the tube 14 comprises two projections 38, in this case in the form of bosses arranged symmetrically on the two flanks 50, 52. These projections 38 are designed to cooperate with means for gripping of the tube 14, of the welding tool, in order to control the position of the tube 14 relative to the tool 10.

FIGS. 6 to 8 represent a welding tool 10 according to the invention. The welding tool 10 makes it possible to weld at least one component such as a mounting bracket 12 on a tube 14 for filling of a fuel tank of a motor vehicle. The mounting bracket 12 is designed to permit the securing of the tube 14 in the vehicle, whilst being firstly welded on an outer surface of the tube 14, and secondly secured on parts of the vehicle.

The tool 10 comprises means for gripping of the tube 14. In this case, these gripping means comprise a jaw 16, which in this case is controlled by at least one pneumatic jack (with the reference 17 in FIGS. 12 and 13), or, according to a variant, by at least one electric jack.

The jaw 16 comprises a fixed part 16A and a mobile part 16B. The fixed part 16A comprises two upper teeth D1, D2, which are spaced from one another by a predetermined distance. The distance between the two teeth is such that the mounting bracket 12 can be inserted between the two teeth in order to access the flattened part. Thus, the upper teeth D1, D2 are disposed such as to clear the access to the flattened part 20, i.e. the surface of the tube 14 on which the mounting bracket 12 is designed to be welded.

The mobile part 16B comprises three lower teeth D3, D4, D5, which are spaced from one another by a predetermined distance. The purpose of the lower teeth is to retain the tube 14 and the tool 10 in a position fixed relative to one another. “Fixed relative to one another” means the fact that the tube 14 is immobile relative to the general position of the tool 10, although parts of the tool 10 are mobile relative to one another, as will be described hereinafter.

In the embodiment illustrated in FIG. 8, the teeth D1 and D2 are identical, i.e. they have the same dimensions and profile. The teeth D3 and D5 are identical, i.e. they have the same dimensions and profile. The tooth D4 has dimensions and a profile different from those of the teeth D3 and D5, since it comprises a presence detector 32. Advantageously, the tooth D4 comprises a receptacle in which the presence detector 32 is inserted and secured.

The profiles of the teeth D1 and D3 are illustrated in FIG. 12. The tooth D1 comprises an upper flat inner surface 161A, and a lower flat inner surface 162A. The upper flat inner surface 161A can come into contact with the flattened part 20. The lower flat inner surface 162A can come into contact with a flat reference flank. The flat inner surfaces 161A and 162A are arranged relative to one another such as to form a “V” or an “L”.

The tooth D3 comprises an upper flat inner surface 161B and a lower flat inner surface 162B. The upper flat inner surface 161B can come into contact with a flat reference flank. The lower flat inner surface 162A can come into contact with, and support, the face of the tube opposite the flattened part. The flat inner surfaces 161B and 162B are arranged relative to one another such as to form a “V” or an “L”.

It will be noted that the profile in the shape of a “V” or an “L” of the upper and lower teeth makes it possible to ensure good isostatism between the tube and the tool.

The tool 10 also comprises means for heating of the flattened part 20 of the tube 14. These means comprise a heating collar 22 and a cylindrical part 24 comprising cylindrical bronze 24 acting as a mirror which permits concentration of the heating on the flattened part 20, when the tube 14 is positioned in the tool 10. When the heating collar 22 is activated, the cylindrical part 24 is heated by the latter by conduction. This cylindrical part 24 has a dimension which, relative to the jaw 16, is designed such that its main face can reach the flattened part 20 of the tube 14. These means for heating of the flattened part 20 of the tube 14 are mobile relative to the jaw 16, between a position of heating of the flattened part 20, and a retracted position. In their retracted position, the heating means are spaced from the tube 14, as represented in FIG. 6. In its position of heating of the flattened part 20, the cylindrical part 24 is in contact with the flattened part 20, and heats the latter by conduction.

The tool 10 comprises means for heating of the mounting bracket 12. These means thus comprise a heating element 26 and a plate 28 which can be heated by the heating element 26.

In addition, the tool 10 comprises means 30 for gripping of the mounting bracket 12. These gripping means 30 can be of any type. They can be a gripper. Preferably, the gripping means 30 comprise at least one electronic sensor and/or at least one microprocessor, making it possible to ensure optimum gripping of the mounting bracket 12.

A description will now be provided of the means for control of the positions of the tube 14, and in particular of the flattened part 20, relative to the tool 10.

As can be seen better in FIG. 8, the means for gripping of the tube 14, in this case a jaw 16, comprise two presence detectors 32 with a thruster 34, which detectors are controlled electronically. The presence detectors 32 are designed to control the position of the flattened part 20. The number of presence detectors 34 is not a limiting characteristic of the invention, and can for example be one or zero.

Each presence detector 32 cooperates respectively with the projecting protrusion 38 shown in FIGS. 4 and 5. In this embodiment, when each detector 32 detects a projection 38 in its direction of detection, the gripping of the tube 14 by the jaw 16 is validated.

In addition, the means 30 for gripping of the mounting bracket 12 comprise at least one detector and one microprocessor which are designed to control the position of the gripping means 30, when they support the mounting bracket 12, relative to the tube 14.

In addition, the means for heating of the tube 14 and the means 30 for gripping of the mounting bracket 12 are mobile relative to one another. The means for heating of the mounting bracket 12, for their part, are fixed relative to the means 22, 24 for heating of the tube 14, and the means 30 for gripping of the mounting bracket.

The means 30 for gripping of the mounting bracket 12 are mobile relative to the heating element 26 and the plate 28. Thus, these means are mobile relative to the means for heating of the mounting bracket 12, between a position of heating of the mounting bracket 12, which in particular is represented in FIG. 6, and a position of welding of the mounting bracket 12 on the flattened part 20. In this last position, the mounting bracket 12 is disposed in direct contact on the flattened part, which is kept immobile by the jaw 16.

In addition, the assembly formed by the heating element 22 and the cylindrical part 24, and the means 30 for gripping of the mounting bracket are integral in translation in a first direction (X), which in this case is horizontal. These elements can be displaced in the direction (X) by means of two translation rails 42. These rails 42, which are parallel, and extend in the direction (X), are connected to the units 44 which support respectively the heating element 22, the cylindrical part 24, and the heating element 26 and the plate 28.

Thus, the means for heating of the flattened part 20 of the tube 14 and the means for gripping of the mounting bracket 12 are integral in translation in the direction (X).

The assembly formed by the heating element 22 and the cylindrical part 24 is also mobile in a second direction (Y), which in this case is vertical, relative to the means for gripping of the tube. This mobility is possible by means of a piston 46, which is connected to the heating element 22 and the plate 24, which in this case operates with electrical energy, and is controlled electronically. According to a variant of the present embodiment, it is controlled electronically, but is mobile thanks to hydraulic energy. According to a third variant, it is controlled mechanically, and is mobile thanks to hydraulic energy.

The means for gripping the mounting bracket 12 are mobile in the direction (Y) relative to the jaw 16, thanks to a piston 48 similar to the piston 46.

Thus, the means for heating of the flattened part 20 of the tube 14 are mobile in the direction (Y), transversely to the direction (X), relative to the means for gripping of the tube 14.

FIG. 9 represents an installation 100 comprising a robot 110 which is electronically controlled, and comprises an arm 112 comprising means 114 for gripping of the tool 10. The robot 110 is designed to position the tool 10, in particular relative to the tube 14.

A brief description will now be provided of a method for welding the mounting bracket 12 on the flattened part 20 of the tube 14, in particular with reference to FIGS. 12 and 13.

Initially, the tool is in its configuration represented in FIG. 6.

Firstly, the robot 110 positions and orients the tool 10 relative to the tube 14. As can be seen in FIG. 12, the mobile part 16B of the jaw 16 progressively approaches the fixed part 16A. As a result of the form of the tube 14, this approach positions and orients the tube 14, such as to dispose the flattened part 20 of the tube 14 opposite the cylindrical part 24.

Then, this cylindrical part 24 is translated in the direction (Y), in order to come into contact with the flattened part 20 of the tube 14 by means of the piston 46. It heats the flattened part 20 of the tube 14 until the latter reaches a suitable welding temperature.

Simultaneously, the plate 28 heats the mounting bracket 12 until it reaches a suitable welding temperature.

Next, the cylindrical part 24 is translated in the direction (Y) in order to return to the position shown in FIG. 6. At the same time, the means 30 for gripping of the mounting bracket 12 grasp the mounting bracket 12. According to a variant, the mounting bracket 12 is grasped at the beginning of the welding process.

Then, the means 30 for gripping of the mounting bracket 12 and the assembly formed by the heating collar 22 and the cylindrical part 24 are translated in the direction (X) along the two rails 42, until the mounting bracket 12 is opposite the flattened part 20.

Next, by means of the piston 48, the means 30 for gripping of the mounting bracket 12 are translated in the direction (Y), until the mounting bracket 12 is in contact with the flattened part 20 of the tube 14. These two parts are kept in contact at least for the time necessary for the welding to take effect. The mounting bracket 12 is then secured on the flattened part 20 as can be seen in FIG. 13.

Then, the means 30 for gripping of the mounting bracket 12 are released from this support, and the jaw 16 releases the tube 14.

FIG. 10 represents another type of component which can be welded on the flattened part 20 of the tube. This component is a line bracket 12A, which makes it possible to attach the tube 14 to another tube 14B as can be seen in FIG. 11.

It will be appreciated that numerous modifications can be made to the invention without departing from its context.

In particular, the means for heating of the flattened part 20 or of the mounting bracket 12 can be modified.

It is also possible to modify the arrangement of the different heating means, as well as their mobility relative to one another.

1. A welding tool with at least one component with a tube for a tank, the tool comprising:
means for gripping of the tube, which are designed to retain the tube and the tool in a position fixed relative to one another;
means for heating of a flattened part which is a surface of the tube designed to be welded on the component;
wherein the means for gripping of the tube comprise a jaw comprising at least one upper tooth and one lower tooth, with the upper tooth comprising at least one first flat inner surface which can come into contact with the flattened part, the lower tooth comprising at least one second flat inner surface which can come into contact with at least one flat reference flank provided on the tube, with the flat reference flank being such that it makes it possible to position the flattened part opposite the means for heating of the flattened part, when the upper and lower teeth approach one another.

2. The tool as claimed in claim 1, wherein the upper tooth comprises two first flat inner surfaces which are arranged relative to one another such as to form a “V”, and the lower tooth comprises two second flat inner surfaces which are arranged relative to one another such as to form a “V”.

3. The tool as claimed in claim 1, wherein it comprises:
means for heating of the component; and
means for gripping of the component, which are mobile relative to the means for heating of the component and relative to the means for gripping of the tube, between a position for heating of the component, and a position for welding of the component onto the flattened part.

4. The tool as claimed in claim 3, wherein the means for heating of the flattened part and the means for heating of the component are combined, for example in the form of a common mirror.

5. The tool as claimed in claim 3, wherein the means for heating of the flattened part and the means for gripping of the component are integral in translation in a first direction.

6. The tool as claimed in claim 3, wherein the means for heating of the component comprise a heating element and a plate which is heated by the heating element, and the means for heating of the flattened part comprise a heating collar and a mirror.

7. The tool as claimed in claim 1, wherein the means for heating of the flattened part are mobile in translation in a second direction, which is preferably transverse to the first direction, relative to the means for gripping of the tube.

8. The tool as claimed in claim 1, which is designed to weld a component of the mounting bracket type, making it possible to secure the tube on a part of a motor vehicle.

9. The tool as claimed in claim 1, which is designed to weld a component of the line bracket type, making it possible to attach the tube to another tube.

10. The tool as claimed in claim 1, which is designed to be used for securing of a tube for filling of a fuel tank of a motor vehicle.

11. A tube for a tank, characterized in that it comprising a flattened part and at least one flat reference flank which are designed to be used with a tool as claimed in claim 1, and a component welded by means of the tool.

12. The tube for a tank as claimed in claim 11, further comprising two flat reference flanks perpendicular to the flattened part.

13. The tube as claimed in claim 11, further comprising at least one projection in order to control the position of the tube relative to the tool.

14. An installation for welding of at least one component on a tube as claimed in claim 11, comprising at least one tool as claimed in at least claim 1, and a robot which is designed to position the tool relative to the tube.
